(19) United States
(12) Patent Application Publication
(10) Pub. No.: US 2020/0319792 A1
(43) Pub. Date: Oct. 8, 2020

(54) DISPLAY DEVICE, DISPLAY SYSTEM COMPRISING SUCH A DEVICE, RELATED DISPLAY METHOD AND COMPUTER PROGRAM

(71) Applicant: THALES, Courbevoie (FR)

(72) Inventors: Maxime DECHATRE, Mérignac (FR); Emmanuel Humbert, Mérignac (FR); Maxime Caillaud, Mérignac (FR); Yannick Le Roux, Mérignac (FR)

(21) Appl. No.: 16/831,262

(22) Filed: Mar. 26, 2020

(30) Foreign Application Priority Data
Apr. 2, 2019 (FR) 19 03490

(51) Int. Cl. G06F 3/0488; G06F 3/01

(52) U.S. Cl. CPC G06F 3/04883; G06F 3/016

(57) ABSTRACT

The invention relates to a display device able to be linked to a touch-sensitive surface and to a display screen. The display device comprises an acquisition module configured to acquire at least one tactile interaction and a determining module configured to determine an operation as a function of the acquired tactile interaction.

The operation determined by the determining module is an operation for displaying a keyboard when the acquired tactile interaction is a designation of an entry field, a data entry operation when the acquired tactile interaction is a designation of at least one entry area and an operation to hide the keyboard when the tactile interaction is a designation of a control area.

The operation determined by the determining module following a data entry operation remains the display operation of the keyboard as long as the designation of the control area has not been acquired.

### CROSS-REFERENCE TO RELATED APPLICATIONS

This application is a U.S. non-provisional application claiming the benefit of French Application No. 19 03490, filed on Apr. 2, 2019, which is incorporated herein by reference in its entirety.

### FIELD

The present invention relates to a device for displaying data on a display screen, the display device being able to be linked to a touch-sensitive surface and to the display screen.

The invention also relates to a data display system, in particular configured to be embedded in an aircraft, comprising a display screen, a touch-sensitive surface and such a display device linked to the touch-sensitive surface and the screen.

The invention also relates to a method for displaying data on a display screen, the method being implemented by an electronic display device able to be linked to a touch-sensitive surface and to the display screen.

The invention also relates to a non-transitory computer-readable medium including a computer program including software instructions which, when executed by a computer, implement such a display method.

### BACKGROUND

The invention relates to the field of data display systems, preferably suitable for being embedded in an aircraft, in particular in an aircraft cockpit.

The invention in particular relates to the field of display devices included in these data display systems, in particular touch-sensitive screens.

A display device of the aforementioned type is known, including a module for acquiring at least one tactile interaction of a user, detected by the touch-sensitive surface, and a module for determining operation(s) as a function of the tactile interaction acquired by the acquisition module.

The determining module of such a device is generally able to determine a display operation of an entry area following the designation of a data entry field and a masking operation of the entry area following the validation or cancellation of the entry or following a scrolling of a displayed area.

However, in an aircraft cockpit, the editable data are critical, and it is then necessary to improve the data entry by the user in such a data entry field.

### SUMMARY

The aim of the invention is therefore to propose a display device making it possible to improve the data entry by the user.

To that end, the invention relates to a device for displaying data on a display screen, the display device being able to be linked to a touch-sensitive surface and to the display screen and comprising:
an acquisition module configured to acquire at least one tactile interaction of a user, detected by the touch-sensitive surface, and
a determining module configured to determine an operation as a function of the acquired tactile interaction,
the determined operation being an operation for displaying an entry keyboard when the acquired tactile interaction is a designation of a data entry field,
the determined operation being a data entry operation in a respective entry field when the acquired tactile interaction is a designation of at least one entry area, included in the entry keyboard previously displayed,
the determined operation being a masking operation of the entry keyboard previously displayed when the tactile interaction is a designation of a control area among a validation area and a cancellation area, said control area being included in the displayed entry keyboard following the designation of a respective entry field,
the determined operation following a data entry operation remains the display operation of the entry keyboard as long as the designation of the control area has not been acquired.

According to other advantageous aspects of the invention, the display device comprises one or more of the following features, considered alone or according to all technically possible combinations:
the determining module is configured to calculate a resizing of the displayed entry keyboard when the tactile interaction is a swipe toward the displayed entry keyboard following the designation of a respective entry field, the size of the entry keyboard being able to vary during said swipe;
the determining module is configured to calculate a restoration of the entry keyboard to its initial size when the swipe is complete and the user's finger having performed this swipe is no longer in contact with the touch-sensitive surface;
in case of designation of a respective entry field located inside an available area to the entry keyboard, the determined display operation of the keyboard includes a shift of the content initially displayed to the inside of a display area of the entry keyboard, included in the available area, outside said display area and a display of the entry keyboard in said display area,
when the tactile interaction is a swipe toward the displayed entry keyboard following the designation of a respective entry field, the shift preferably being in the direction of said swipe;
in case of designation of a respective entry field located outside an available area for the entry keyboard, the display operation of the determined keyboard includes a display of the entry keyboard in a display area included in the available area;
following the designation of a respective entry field and the designation of at least one respective entry area, the acquisition module is configured to ignore the designation of other entry field(s) as long as the designation of the control area has not been acquired; and
the device further comprises a display module configured to display the determined operation on the display screen.

The invention also relates to a data display system, in particular configured to be embedded in an aircraft, the display system comprising a display screen, a touch-sensitive surface, and a device for displaying information on the display screen, the display device being linked to the touch-sensitive surface and to the screen, the display device being a device as defined above.

The invention also relates to a method for displaying data on a display screen, the method being implemented by an electronic display device able to be linked to a touch-sensitive surface and to the display screen and comprising the following steps:
acquiring at least one tactile interaction of a user, detected by the touch-sensitive surface, and
determining an operation as a function of the acquired tactile interaction,
the determined operation being an operation for displaying an entry keyboard when the acquired tactile interaction is a designation of a data entry field,
the determined operation being a data entry operation in a respective entry field when the acquired tactile interaction is a designation of at least one entry area, included in the entry keyboard previously displayed,
the determined operation being a masking operation of the entry keyboard previously displayed when the tactile interaction is a designation of a control area among a validation area and a cancellation area, said control area being included in the displayed entry keyboard following the designation of a respective entry field,
the determined operation following a data entry operation remains the display operation of the entry keyboard as long as the designation of the control area has not been acquired.

The invention also relates to a non-transitory computer-readable medium including a computer program including software instructions which, when executed by a computer, implement a method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an aircraft equipped with an electronic data display system according to the invention, comprising a display screen, a touch-sensitive surface and an electronic device for displaying information on the display screen;

FIG. 2 is a set of views successively displayed on the screen, according to a first exemplary data display according to the invention;

FIG. 3 is a set of views similar to those of FIG. 2, according to a second exemplary data display according to the invention; and

FIG. 4 is a flowchart of the data display method according to the invention.

### DETAILED DESCRIPTION

In the remainder of the description, the expression “substantially equal to” defines a relationship of equality to within plus or minus 10%, preferably to within plus or minus 5%.

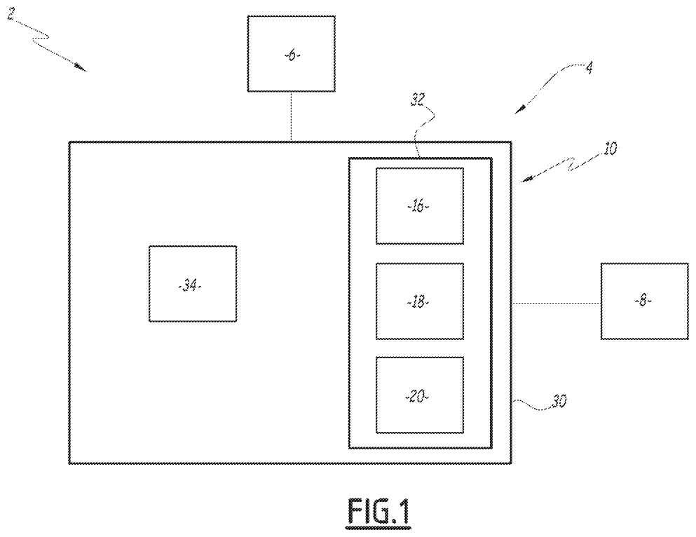

In FIG. 1, an aircraft 2 comprises an electronic data display system 4, including a display screen 6, a touch-sensitive surface 8 and a device 10 for displaying data on the display screen 6. The data display device 10 is linked to the display screen 6 and the touch-sensitive surface 8.

The aircraft 2 is preferably an airplane. Alternatively, the aircraft 2 is a helicopter or a drone.

In the example of FIG. 1, the display device 10 is embedded in the aircraft 2.

The data display device 10 comprises a module 16 for acquiring at least one tactile interaction of a user, detected by the touch-sensitive surface 8.

The data display device 10 comprises a module 18 for determining an operation as a function of the tactile interaction acquired by the acquisition module 16.

The display device 10 comprises a module 20 for displaying, on the display screen 6, the operation determined by the determining module 18.

In the example of FIG. 1, the display device 10 comprises an information processing unit 30, for example made up of a memory 32 associated with a processor 34.

In the example of FIG. 1, the acquisition module 16, the determining module 18 and the display module 20 are each made in the form of software executable by the processor 34. The memory 32 is then able to store acquisition software for at least one tactile interaction by a user, software for determining an operation and software for displaying the determined operation. The processor 34 of the information processing unit 30 is then able to execute the acquisition software, the determining software and the display software.

In a variant that is not shown, the acquisition module 16, the determining module 18 and the display module 20 are each made in the form of a programmable logic component, such as an FPGA (Field Programmable Gate Array), or in the form of a dedicated integrated circuit, such as an ASIC (Application-Specific Integrated Circuit).

When the electronic display device 10 is made in the form of one or several software programs, i.e., in the form of a computer program, it is further able to be stored on a medium, not shown, readable by computer. The computer-readable medium is for example a medium suitable for storing electronic instructions and able to be linked with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The touch-sensitive surface 8 is for example a capacitive touch-sensitive surface, typically placed on the display screen 6. The display screen 6 combined with the touch-sensitive surface 8 forms a touch-sensitive screen.

The acquisition module 16 is configured to acquire at least one tactile interaction by a user. The tactile interaction by the user is for example detected by the touch-sensitive surface 8.

In addition, the acquisition module 16 is configured to acquire the position of the at least one tactile interaction over time.

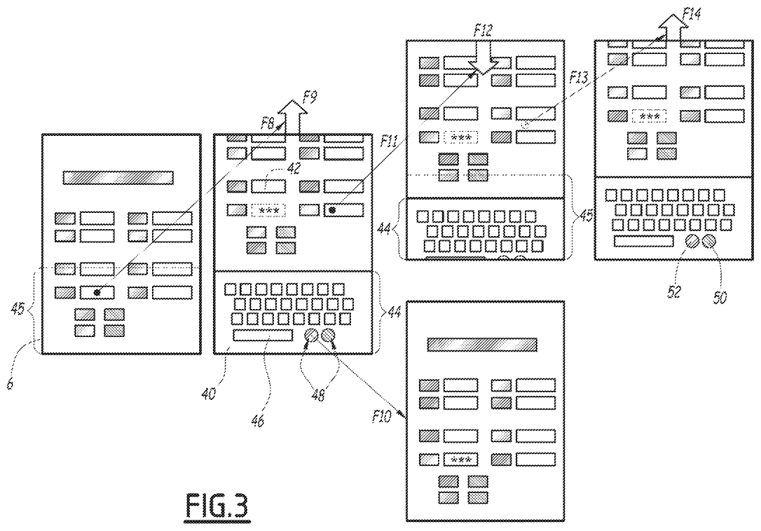

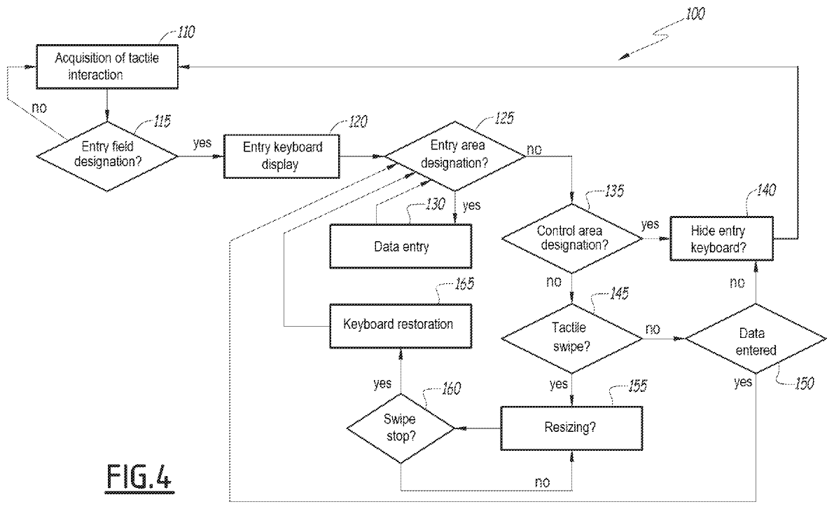

The display data comprise a data entry keyboard 40, visible in FIGS. 3 and 4. The display data comprise a data entry field 42, a display area 44 of the entry keyboard 40 and an area 45 available to the entry keyboard. The display area 44 of the entry keyboard has a variable size and extends more or less over the available area 45. The display data are intended to be displayed on the available screen 6, as a function of tactile interaction(s) by the user.

The available area 45 for example extends over one third of the display screen 6.

The data entry keyboard 40 comprises an entry area 46, as well as a control area 48.

The entry keyboard 40 extends in the display area 44 of the entry keyboard, that is to say, is able to occupy said entry area 44 when it is displayed. The display area 44 then occupies all or part of the available area 45. The display area 44 occupies the entire available area 45 when the entry keyboard 40 is displayed in a completely deployed manner.

The entry area 46 for example comprises a set of keys, such as alphanumeric keyboard keys. The entry area allows the user to enter data in a respective entry field 42.

The control area 48 for example comprises a validation area 50 and a cancellation area 52. The control area 48 allows the user to control an action on data previously acquired, such as a validation of the entered data, or a partial or complete cancellation of the data entry previously done. The control area 48 also allows the user to control the display data.

The validation area 50 for example makes it possible to validate data entered in a respective data entry field 42, and is for example in the form of an “Enter” key of the keyboard 40.

The cancellation area 52 for example makes it possible to cancel data entered in a respective data entry field 42, and is for example in the form of an “Exit” or “Cancel” key of the keyboard 40.

The tactile interaction is for example a tactile swipe or a tactile designation. A tactile designation is an interaction in which the position of the tactile interaction against the touch-sensitive surface 8 extends over a distance below a predefined distance threshold, for example substantially equal to 12 mm. A tactile swipe is for example an interaction in which the position of the interaction extends over more than 12 mm. In the case where the screen 6 is combined with the tactile surface 8 to form a touch-sensitive screen, the designated element is the element that the user touches on the screen 6.

The determining module 18 is configured in order, from the interaction acquired by the acquisition module 16, to determine an operation to the next be displayed on the screen 6. The operation to be displayed on the screen 6 is for example a display operation of the entry keyboard 40, a data entry operation or a masking operation of the entry keyboard 40.

The operation determined by the determining module 18 is a display operation of the data entry keyboard 40 if the tactile interaction is a designation of the data entry field 42. The designation of the entry field 42 corresponds to a tactile interaction in which the position of the designation is that of the data entry field 42.

The operation determined by the determining module 18 is a data entry operation if the acquired tactile interaction is the designation of a respective entry area 46 included in the entry keyboard. The designation of a respective entry area 46 corresponds to a tactile interaction in which the position of the designation is that of the entry area 46.

The operation determined by the determining module 18 is a masking operation of the entry keyboard previously displayed if the tactile interaction is a designation of the control area 48. The designation of the control area 48 corresponds to a tactile interaction in which the position of the designation is that of the control area 48.

The determining module 18 is configured so that the determined operation following a data entry operation remains the display operation of the entry keyboard as long as the designation of the control area 48 has not been acquired. In other words, the entry keyboard 40 remains displayed as long as the user does not designate a respective control area 48, for example the validation area 50 or the cancellation area 52.

The display operation of the data entry keyboard comprises displaying the entry keyboard 40 in the display area 44 of the data entry keyboard, said display area 44 extending inside the available area 45.

The display operation of the entry keyboard 40 comprises, in case of designation of an entry field 42 located inside the available area 45, a shift outside said available area 45 of content initially displayed inside the available area 45. The display data located next to the screen 6 that is opposite the entry keyboard 40, on a surface area equal to the surface area of the entry keyboard 40, are then no longer displayed. For example, if the entry keyboard 40 is displayed in the lower part of the screen 6, then the data, initially displayed in the upper part of the screen 6 and corresponding to the surface area of the display area 44, are no longer displayed following this shift.

The display operation of the entry keyboard 40 comprises, in case of designation of an entry field 42 located outside the available area 45, a display of the entry keyboard 40 inside said available area 45. The display data previously displayed in the available area 45 are then no longer displayed, these data being replaced by the entry keyboard 40.

The determining module 18 is configured to calculate a resizing of the displayed entry keyboard 40 when the tactile interaction is a swipe toward the entry keyboard 40, which has been displayed following the designation of a respective entry field 42. The size of the displayed entry keyboard 40, and therefore of the display area 44, can vary during the swipe. In particular, the calculation of the resizing of the entry keyboard 40 is initiated when a portion of the swipe is oriented toward the entry keyboard 40.

One skilled in the art will then understand that if the swipe for example first includes a first swipe portion in the direction opposite the keyboard, for example upward if the entry keyboard 40 is displayed at the bottom of the screen 6, then a second swipe portion toward the keyboard, then the calculation of the resizing of the entry keyboard 40 will only be initiated as of the second swipe portion. Swipe portion oriented toward the keyboard means that said swipe portion is for example oriented downward if the entry keyboard 40 is displayed at the bottom of the screen 6, or conversely upward if the entry keyboard 40 is displayed at the top of the screen 6, that is to say, a component of said swipe portion is in the vertical direction in this case, but not necessarily that said portion extends in the vertical direction.

The size of the entry keyboard 40, and therefore of the display area 44, is then decreased when the swipe is toward the entry keyboard 40, and is increased when the swipe is in the direction opposite the entry keyboard 40, all throughout the tactile interaction. One skilled in the art will then understand that during this tactile swipe, the size of the display area 44 can vary between a nil size corresponding to a disappearance of the entry keyboard 40 and a maximum size corresponding to the available area 45.

The display operation of the entry keyboard 40 then comprises, following the designation of the data entry field located inside the available area 45, and if the tactile interaction is a swipe toward the displayed entry keyboard 40, a shift of the content initially displayed to the inside of the available area 45 in the direction of said swipe. The shifted display data then for example replace the entry keyboard 40.

The display operation of the entry keyboard 40 comprises, in case of designation of a data entry field located outside the available area 45, and if the tactile interaction is a swipe toward the displayed entry keyboard 40, a shift of the entry keyboard 40 along the direction of said swipe. The display data previously displayed in the available area 45 and covered by the entry keyboard 40 are then visible again.

The determining module 18 is configured to calculate a restoration of the entry keyboard 40 following the resizing of the entry keyboard 40. The determining module 18 is in particular configured to calculate a restoration of the entry keyboard 40 to its initial size when the swipe is complete and the user's finger having performed this swipe is no longer in contact with the touch-sensitive surface 8. The size of the entry keyboard 40 at the end of the restoration is identical to that at the beginning of the resizing of the entry keyboard 40. The display data displayed by the device 10 are for example the same at the end of the restoration as at the beginning of the resizing. As an example, the restoration takes place between 250 ms and 350 ms after stopping the contact between the user's finger and the touch-sensitive surface 8.

The acquisition module 16 is configured to ignore the designation of at least one other entry field 42, following the designation of a respective entry field 42 and the designation of a respective entry area 46 in the entry keyboard 40. The acquisition module 16 is then configured to ignore the designation of other entry field(s) as long as the designation of the control area 48 has not been acquired.

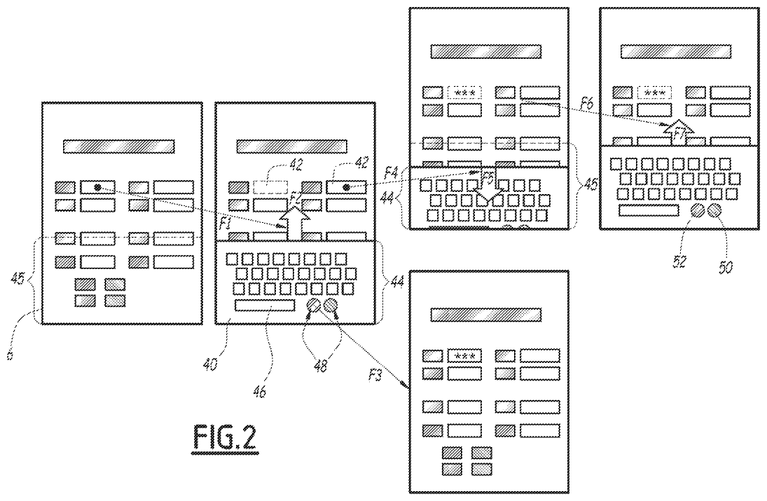

The operation of the display device 10 according to the invention will now be disclosed in reference to FIGS. 2 and 3, showing sets of views successively displayed on the screen 6 according to two exemplary data displays on the display screen 6, as well as in reference to FIG. 4, showing a flowchart of the display method 100 shared by these two examples.

The display method 100 begins with an acquisition step 110 for acquiring at least one tactile interaction by a user, detected by the touch-sensitive surface 8.

During the acquisition step 110, the acquisition module 16 acquires a tactile interaction.

The acquisition step 110 is followed by a step 115 for testing the designation of the entry field. During step 115, the acquisition module 16 acquires at least one tactile interaction from a user, then tests whether a respective entry field 42 has been designated. If the test performed during the entry field designation test step 115 is positive, that is to say, if the acquired tactile interaction is a designation of a respective entry field 42, then a display operation of the entry keyboard is determined by the determining module 18 during a following step 120. During step 120, the display module 20 then displays this operation previously determined by the determining module 18, that is to say, displays the entry keyboard 40. The display module 20 in particular displays the entry keyboard 40 in its entirety in the display area available to the entry keyboard 45. If the test performed during the entry field designation test step 115 is negative, that is to say, the tactile interaction is not the designation of an entry field, then the display device 10 returns to the acquisition step 110 to perform a new acquisition.

A first exemplary display of the entry keyboard 120 is visible in FIG. 2. This FIG. 2 illustrates five display configurations of the data on the screen 6 according to this first example and as a function of different designated areas. This first example corresponds to the designation of a data entry field 42 located beyond, that is to say, outside of, the available area 45. The entry keyboard 40 is then displayed in the available area 45 to replace data previously displayed in the available area 45, this transition with display of the entry keyboard 40 being illustrated by arrow F1. The display of the entry keyboard 40 is illustrated by the arrow F2, showing the direction in which the entry keyboard 40 appears in this example.

A second exemplary display of the entry keyboard 40 is visible in FIG. 3. This FIG. 3 illustrates five display configurations of the data on the screen 6 according to this second example and as a function of different designated areas. This second example corresponds to the designation of a data entry field 42 located inside the available area 45. The entry keyboard 40 is then displayed in the available area 45. The data previously displayed on the display screen 6 are then shifted in the direction opposite the entry keyboard 40, this transition with display of the entry keyboard 40 being illustrated by arrow F8. The display of the entry keyboard 40 and the shift of the set of displayed data is illustrated by arrow F9, in this example showing the direction in which the entry keyboard 40 appears and the data are shifted.

Following step 120, an entry area designation test step 125 is carried out. During step 125, the acquisition module 16 acquires at least one tactile interaction from a user, then tests whether a respective entry area 46 has been designated. If the test performed during this entry area designation test step 125 is positive, that is to say, if a respective entry area 46 of the entry keyboard 40 is designated, then the method goes to a data entry step 130. If the test performed during this test step 125 is negative, that is to say, if a respective entry area 46 is not designated, then the method goes to a control area designation test step 135.

During step 130, the determining module 18 determines a data entry operation, then the display module 20 displays the determined operation and then performs the display, in the data entry field 42 previously designated, of the datum designated by the entry area 46. After step 130, the method returns to the entry area designation test step 125.

During the control area designation test step 135, the acquisition module 16 acquires at least one tactile interaction from a user, then tests whether a respective control area 48 has been designated. If the test performed during this step 135 is positive, that is to say, if a control area 48, such as a validation 50 or cancellation 52 area has been designated, then the display device 10 goes to step 140. If the test performed during this step 135 is negative, that is to say, if a control area 48 has not been designated, then the display device 10 goes to a tactile swipe test step 145.

During step 140, the determining module 18 determines a masking operation of the keyboard 40, then the display module 20 displays the determined operation and then performs the masking operation of the keyboard 40, that is to say, causes the keyboard 40 to disappear from the screen 6, or in other words eliminates the entry keyboard 40 from the display screen 6. Step 140 is in particular illustrated in FIGS. 2 and 3, where the arrows F3 and F10 show the transition of the display between before the masking operation, in other words when the keyboard 40 is displayed, and after the masking operation.

If the designated control area 48 is a respective validation area 50, then, during step 140 and the masking of the entry keyboard 40, the data previously entered in the entry field 42 are retained. Conversely, if the designated control area 48 is a respective cancellation area 52, then the data previously entered in the entry field 42 are deleted during step 140 and the masking of the entry keyboard 40.

After step 140, the display device 10 returns to the initial step 110, and the display data displayed on the screen 6 are then similar to those displayed before the designation of the data entry field 42, the display data differing only by any refreshing of data displayed on the screen and/or by any data entered in the data entry field 42, as illustrated in FIGS. 2 and 3 by stars “*”.

During the tactile swipe test step 145, the acquisition module 16 acquires at least one tactile interaction from a user, then tests whether a tactile swipe has been acquired. If the test performed during this step 145 is negative, that is to say, if the tactile interaction is a designation, then the display device 10 goes to an entered data test step 150. If the test performed during this step 145 is positive, that is to say, if the tactile interaction is a swipe, then the display device 10 goes to a step 155.

During the entered data test step 150, the acquisition module 16 acquires at least one tactile interaction from a user, then tests whether a respective entry field 42 has been designated. If the test performed during this step 150 is positive, that is to say, if at least one datum is present in the entry field 42, then the display device 10 returns to step 125. If on the contrary the test performed during this step 150 is negative, that is to say, if no datum is present in the entry field 42, then the display device 10 goes to step 140 previously described.

During step 155, the determining module 18 determines a resizing operation, then the display module 20 displays the determined operation and then displays the entry keyboard 40 with its dimensions modified by the determined resizing operation. The size of the entry keyboard 40 is in particular reduced during swipe toward the entry keyboard, and increased during a swipe in the direction opposite the entry keyboard 40.

FIG. 2 illustrates step 155 in the case where the designated entry field 42 is located outside the available area 45. The size of the entry keyboard 40 varies as a function of the swipe by the user, the transition due to the swipe being represented by arrow F4 and the direction of the swipe and resizing of the keyboard being illustrated by arrow F5. During step 155, the keyboard 40 covers or exposes the display data previously displayed in the available area 45.

FIG. 3 likewise illustrates step 155 in the case where the designated entry field is located in the available area 45. The size of the entry keyboard 40 varies as a function of the swipe by the user and shifts the display data as a function of the size of the display keyboard 40. The transition due to the swipe is shown there by arrow F11 and the direction of the swipe and the resizing of the keyboard as well as the shift of the display data is illustrated by arrow F12.

After step 155, the display device 10 goes to a swipe stop test step 160.

During the swipe stop test step 160, the acquisition module 16 acquires at least one tactile interaction from a user, then tests whether the tactile swipe is ongoing or has been completed. In particular, the determining module 18 determines whether the user's finger has moved away from the touch-sensitive surface 8. If the test performed during this step 160 is negative, that is to say, if the swipe is still in progress, then the display device 10 returns to step 155. One skilled in the art will understand here that the resizing continues as long as the swipe 155 is in progress. If the test performed during this step 160 is positive, that is to say, if the swipe is stopped and the user has moved his finger away from the touch-sensitive surface, then the display device 10 goes to a step 165.

During step 165, the determining module 18 determines a restoration operation of the entry keyboard 40, then the display module 20 displays the determined operation and then displays the entry keyboard 40 with its restored dimensions, that is to say, with its dimensions prior to step 155. In other words, the entry keyboard 40 is then displayed again with its default dimensions, for example predefined, that it had before being resized by the tactile swipe from the user's finger.

Step 165 is illustrated in FIGS. 2 and 3. In FIG. 2, arrow F6 shows the transition between a state where the keyboard 40 is resized and a state where the keyboard 40 is restored, arrow F7 illustrating the movement of said keyboard 40 during the restoration operation 165. In FIG. 3, arrow F13 shows the transition between a state where the keyboard 40 is resized and a state where the keyboard 40 is restored, arrow F14 showing the movement of said keyboard 40 as well as the set of display data during step 165 with restoration of the keyboard 40 to its dimensions prior to the resizing done during step 155. When the swipe is released, that is to say, during step 165 following a positive test during step 160, the keyboard 40, and respectively the set of display data, are identical to the keyboard 40, and respectively to the set of data, present before the tactile swipe, to within any optional refresh of the data displayed on the screen 6.

After step 165, the display device 10 returns to step 125.

In the case where data have been entered in the entry field 42, the designation of a control area 48 is then necessary to conceal the entry keyboard 40, the operation determined after a data entry operation remaining the display operation of the entry keyboard 40 while the designation of said control area 48 is not acquired.

One can thus see that the data display device 10 and the display method according to the invention make it possible to improve the entry of data by the user.

1. An electronic device for displaying data on a display screen, the display device being able to be linked to a touch-sensitive surface and to the display screen, and comprising:
an acquisition module configured to acquire at least one tactile interaction of a user, detected by the touch-sensitive surface, and
a determining module configured to determine an operation as a function of the acquired tactile interaction,
the determined operation being an operation for displaying an entry keyboard when the acquired tactile interaction is a designation of a data entry field,
the determined operation being a data entry operation in a respective entry field when the acquired tactile interaction is a designation of at least one entry area, included in the entry keyboard previously displayed,
the determined operation being a masking operation of the entry keyboard (40) previously displayed when the tactile interaction is a designation of a control area (48) among a validation area and a cancellation area, said control area being included in the displayed entry keyboard following the designation of a respective entry field,
wherein the determined operation following a data entry operation remains the display operation of the entry keyboard as long as the designation of the control area has not been acquired.

2. The display device according to claim 1, wherein the determining module is configured to calculate a resizing of the displayed entry keyboard when the tactile interaction is a swipe toward the displayed entry keyboard following the designation of a respective entry field, the size of the entry keyboard being able to vary during said swipe.

3. The display device according to claim 2, wherein the determining module is configured to calculate a restoration of the entry keyboard to its initial size when the swipe is complete and the user's finger having performed this swipe is no longer in contact with the touch-sensitive surface.

4. The display device according to claim 1, wherein, in case of designation of a respective entry field located inside an available area to the entry keyboard, the determined display operation of the keyboard includes a shift of the content initially displayed to the inside of a display area of the entry keyboard, included in the available area, outside said display area and a display of the entry keyboard in said display area,
when the tactile interaction is a swipe toward the displayed entry keyboard following the designation of a respective entry field.

5. The display device according to claim 4, wherein the shift is in the direction of the swipe.

6. The display device according claim 1, wherein, in case of designation of a respective entry field located outside an available area for the entry keyboard, the display operation of the determined keyboard includes a display of the entry keyboard in a display area included in the available area.

7. The display device according to claim 1 wherein, following the designation of a respective entry field and the designation of at least one respective entry area, the acquisition module is configured to ignore the designation of other entry field(s) as long as the designation of the control area has not been acquired.

8. The display device according to claim 1, wherein the device further comprises a display module configured to display the determined operation on the display screen.

9. An electronic system for displaying data, the display system comprising:
a display screen;
a touch-sensitive surface; and
an electronic device for displaying information on the display screen, the display device being linked to the touch-sensitive surface and the screen,
wherein the display device is according to claim 1.

10. The system according to claim 9, wherein the system is intended to be embedded in an aircraft.

11. A method for displaying data on a display screen, the method being implemented by an electronic display device able to be linked to a touch-sensitive surface and to the display screen, and comprising the following steps:
acquiring at least one tactile interaction of a user, detected by the touch-sensitive surface, and
determining an operation as a function of the acquired tactile interaction,
the determined operation being an operation for displaying an entry keyboard when the acquired tactile interaction is a designation of a data entry field,
the determined operation being a data entry operation in a respective entry field when the acquired tactile interaction is a designation of at least one entry area, included in the entry keyboard previously displayed,
the determined operation being a masking operation of the entry keyboard previously displayed when the tactile interaction is a designation of a control area among a validation area and a cancellation area, said control area being included in the displayed entry keyboard following the designation of a respective entry field
wherein the determined operation following a data entry operation remains the display operation of the entry keyboard as long as the designation of the control area has not been acquired.

12. A non-transitory computer-readable medium including a computer program comprising software instructions which, when executed by a computer, carry out a method according to claim 11.
